(19) United States
(12) Patent Application Publication
(10) Pub. No.: US 2004/0019569 A1
(43) Pub. Date: Jan. 29, 2004

(54) Online real-time information inquiry method and system for importing commodities

(76) Inventors: Yun-Chi Lee, Taipei (TW); Wen-Yi Chang, Taipei (TW); Yueh-Chiu Lin, Taipei (TW)

Correspondence Address: BIRCH STEWART KOLASCH & BIRCH, PO BOX 747, FALLS CHURCH, VA, 22040-0747, US

(21) Appl. No.: 10/403,047

(22) Filed: Apr. 1, 2003

(30) Foreign Application Priority Data
Jul. 25, 2002 (TW) 091116543

(51) Int. Cl. G06F 17/60

(52) U.S. Cl. 705/64

(57) ABSTRACT

An online real-time information inquiry method and system for importing commodities is provided, for allowing a user identification module to search access rights of users from corresponding to identification codes entered from the users via a network terminal device. Next, a data-searching module searches data of importing commodities according to the access rights of the users and consistent with inquiry conditions entered from the users via the network terminal device, and displays the searched data on the network terminal device. Then, an inquiry learning module records and stores data frequently inquired by the users in the database, so as to allow the data-searching module to perform other data inquiries from the users based on refined inquiry conditions or data scope according to the records established in the database by the inquiry learning module, to thereby enhance efficiency of the data inquiry.

### FIELD OF THE INVENTION

The present invention relates to online real-time information inquiry methods and systems for importing commodities, and more particularly, to an online real-time information inquiry method and system for allowing users to access information about importing commodities through a network communication system.

### BACKGROUND OF THE INVENTION

Due to the flourishing developments of the information technologies, a variety of products with all kinds of functions have been developed while the price has become lower and lower. Thus the information technology becomes one of the most important industries. In these years, Taiwan has been the most important host for fabricating products of information technologies. However, due to the lack of natural resources in Taiwan, to import many of the raw materials from other countries has become a compulsory task. Such a need of importing commodities from other countries has induced the problems of Customs services and tax-bonded operation flows for importing commodities. On the other hand, after the enrollment of the World Trade Organization (WTO), the international trade will become even more important for our economical developments. Since the Customs barrier has been demolished, the demand for importing commodities and the frequency of international trade will certainly be largely increased making it more competitive for the commodities from different countries.

When importing commodities from other countries via either air cargo or ocean cargo, for example, the related importing Customs data includes importer company, Customs service company, bill of lading master waybill number, bill of lading house waybill number, trade condition, number of pieces, total gross weight, total net weight, total price and Customs control number. Since the bill of lading is valid in legal aspects or in trading convention, the transfer of bill of lading is regarded as the transfer of ownership. It is thus very important to properly manage the data on the bill of lading. Moreover, since most of the raw materials imported are manufactured into end products and exported to other countries, it may also concern the tax-bonded problem. That is, according to our Customs tax law, if the imported raw material is to be exported after the end product has been fabricated, this specific imported raw material does not need to pay any Customs tax. Also, if the end product exporter is regarded as a reliable company, the company doesn't even need to run into the trouble of the pay-tax and return-tax process for tax-free purpose. Therefore, it is very important to get the Customs data of importing commodities accurately and rapidly under control.

The well-known processing of the Customs data mostly starts from entering the detailed data into the data processing system, such as a computer, after the reception of the Customs bill. When the user wishes to perform an inquiry, the data is then searched from the computer. Although it is very convenient to store the data in a computer, the user still needs to use a computer connected with the database that stores the Customs data. If the user is at a remote location, then the database may not be accessed. The information of Customs data may only be obtained by conventional means, e.g. fax. For this reason, it is compelled to improve the management efficiency of the current data inquiry system. And, it is also compelled to develop a more efficient information inquiry method and system for importing commodities.

### SUMMARY OF THE INVENTION

In order to overcome the drawbacks of the prior art described above, an objective of the present invention is to provide an online real-time information inquiry method and system for importing commodities, so that the importing commodities information inquiry may be performed, online and in real-time, by using a terminal device that is connected with a network through a network communication system.

Another objective of the present invention is to provide an online real-time information inquiry method and system for importing commodities that may refine the inquiry criteria when using it repeatedly, thus to enhance the inquiry efficiency.

To achieve the above and other objectives, the present invention of an online real-time information inquiry system includes a data processing workstation, a database, a user identification module, a data-searching module, and an inquiry learning module. The data processing workstation provides a system data manager of the online real-time information inquiry system for importing commodities to perform the input and output processing of the content of the importing commodities Customs data. The database stores including at least the detailed Customs data of importing commodities, the user identification code and the corresponding data of access rights. The user identification module searches the corresponding access limit from the database according to the identification code entered through a network terminal device. The data-searching module searches the Customs data of importing commodities from the database according to the searching criteria entered through a network terminal device and matched the user access rights. The inquiry learning module records the inquiry inertia of a user and the data frequently hit by an inquiry, the data-searching module may then accordingly refine the searching criteria when performing the data inquiry again.

The method to perform an online real-time information inquiry for importing commodities through the online real-time information inquiry system for importing commodities is the following. First, a user enters an identification code on a network terminal device. Then, based on the identification code entered through the network terminal device, the user identification module searches the database to see if there is any access limit of the corresponding identification code. If there is no such access limit, then jump to the last step. If there is, then the user identification module outputs a signal to the network terminal device and the data-searching module, respectively, so that the user may enter searching criteria via the network terminal device. Next, the data-searching module searches the database based on the searching criteria entered by the user and finds the corresponding data of importing commodities that matches the searching criteria and the access rights. Further, the inquiry learning module records the inquiry inertia of the user who performs the inquiry through the data-searching module and the data frequently hit by an inquiry into the database. The data-searching module may thus refine the searching criteria based on the records established in the database by the inquiry learning module and enhance the inquiry efficiencies. Finally, the inquiry is terminated.

In contrast to the well-known data processing and inquiry method, the present invention of an online real-time information inquiry method and system for importing commodities may provide the user with a mean to inquire the importing commodities Customs information, online and in real-time, on a network terminal device via a network communication system. Moreover, the searching conditions or criteria may be refined according to the inquiry inertia of a user and the data frequently hit by an inquiry when using it repeatedly, and the inquiry efficiencies may be enhanced.

### BRIEF DESCRIPTION OF THE DRAWINGS

The present invention can be more fully understood by reading the following detailed description of the preferred embodiments, with reference made to the accompanying drawings, wherein:

FIG. 1 is a block diagram showing application structure of an online real-time information inquiry system for importing commodities according to the invention;

FIG. 2 is a block diagram showing systematic structure of the online real-time information inquiry system for importing commodities according to the invention;

FIGS. 3A to 3D are schematic diagrams showing data fields of a database used in the online real-time information inquiry system for importing commodities according to the invention;

FIGS. 4A to 4D are schematic diagrams showing web pages in operation of the online real-time information inquiry system for importing, commodities according to the invention; and

FIG. 5 is a flow diagram showing procedural steps for performing an online real-time information inquiry system for importing commodities according to the invention.

### DETAILED DESCRIPTION OF PREFERRED EMBODIMENTS

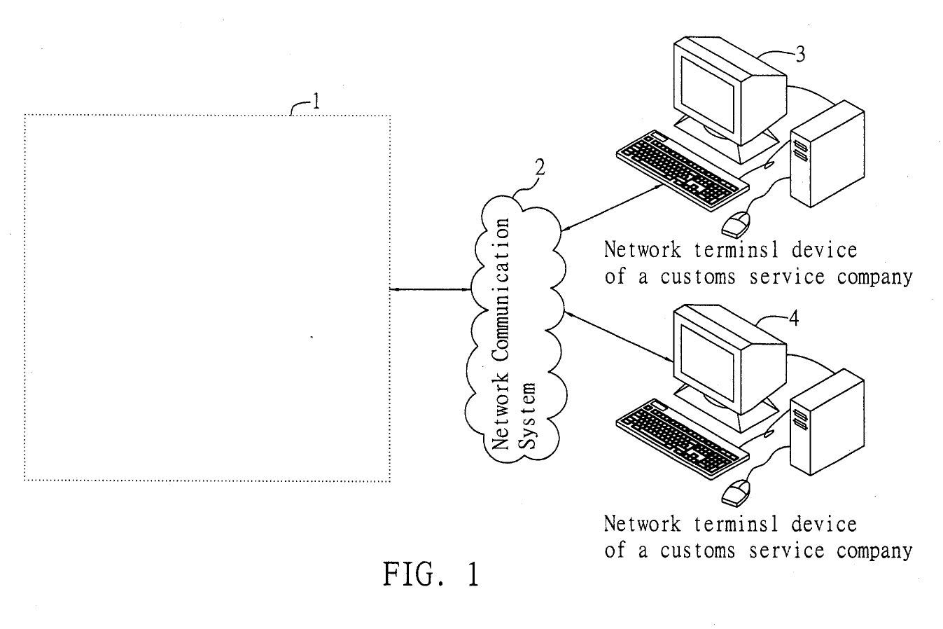

FIG. 1 illustrates application structure of an online real-time information inquiry system for importing commodities 1 according to the present invention, which is connected with a network terminal device of a Customs service company 3 and a network terminal device of an importer company 4 via a network communication system 2. The network communication system 2 may be an Internet or an Extranet. The network terminal device of a Customs service company 3 and the network terminal device of an importer company 4 may be a personal computer (PC) or a notebook computer (NB). The system structure of the network communication system 2 is of the prior art, the discussion of which is thus neglected.

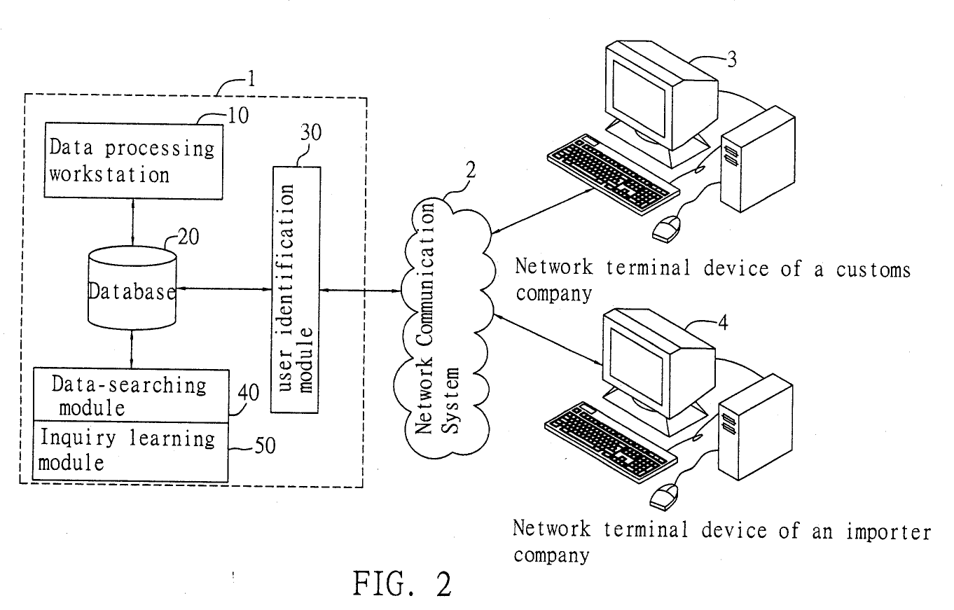

FIG. 2 illustrates system structure of the online real-time information inquiry system, for importing commodities according to the invention. As shown in the drawing, the online real-time information inquiry system for importing commodities includes a data processing workstation 10, a database 20, a user identification module 30, a data-searching module 40 and an inquiry learning module 50.

The data processing workstation 10 provides the system manager of the online real-time information inquiry system for importing commodities 1 to perform data inputs and outputs. In this particular embodiment, the data processing workstation 10 may be a server.

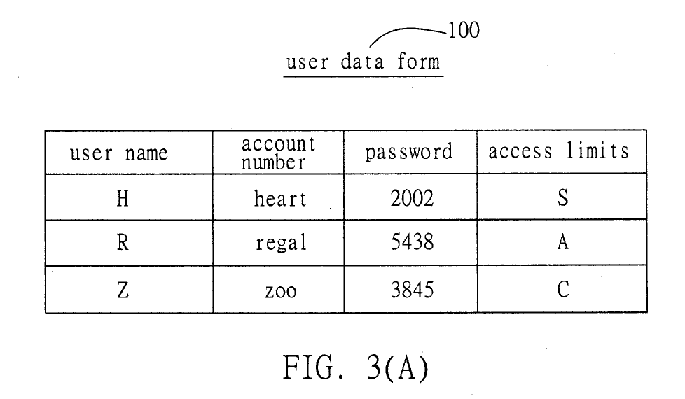

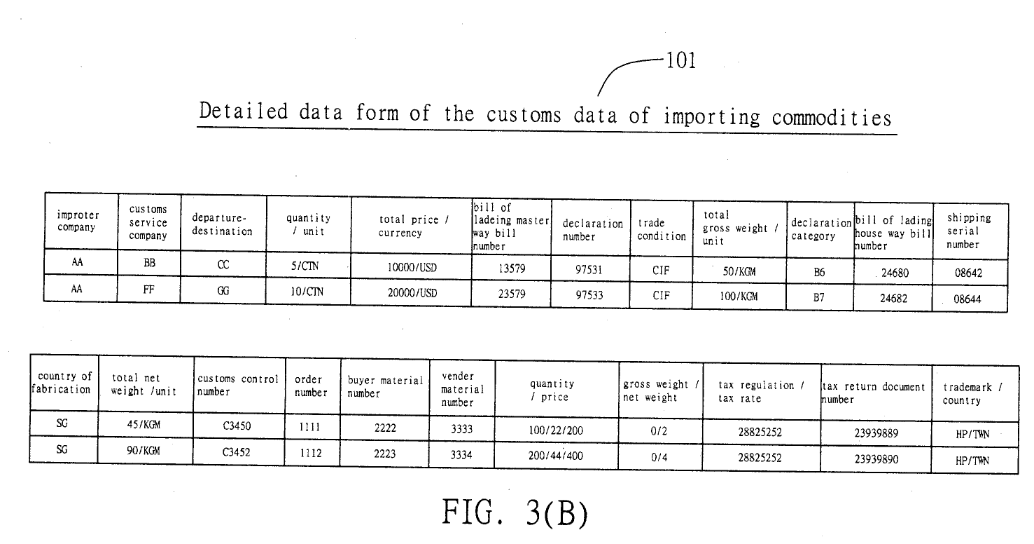

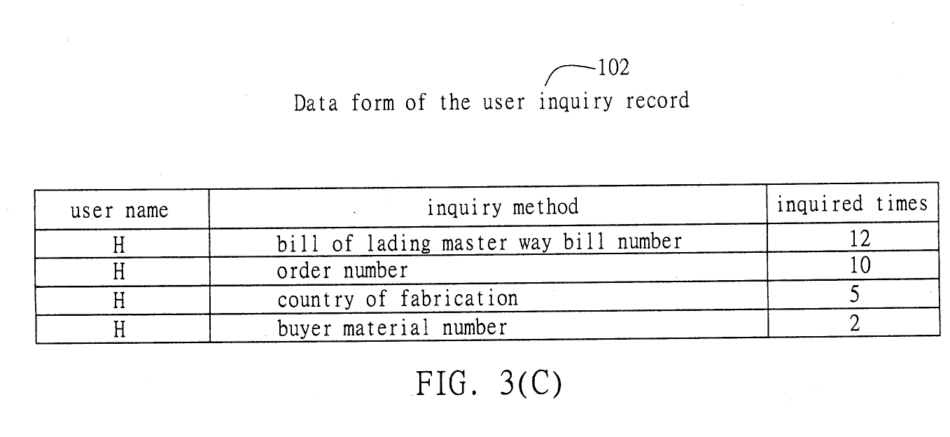

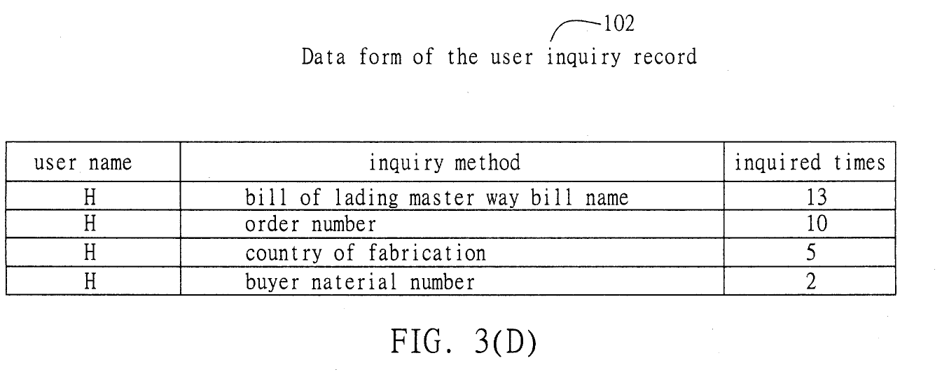

The database 20 provides the online real-time information inquiry system for importing commodities 1 to store the detailed Customs data of importing commodities, the user identification code and the corresponding access rights entered from the data processing workstation 10. The database 20 may also store the inquiry inertia of a user and the data frequently hit by an inquiry. In this particular embodiment, in order to enhance the data inquiry and searching efficiencies, the database 20 may be an associative database. The structure of the database 20 may, as an example shown in FIG. 3A, be a user data form 100 comprising the data fields of user name, account number, password and access rights, or, as an example shown in FIG. 3B, be a detailed data form of the Customs data of importing commodities 101 comprising the data fields of importer company, Customs service company, departure-destination, quantity/unit, total price/currency, bill of lading master waybill number, declaration number, trade condition, gross weight/unit, declaration category, bill of lading house waybill number, shipping serial number, country of fabrication, total net weight/unit, Customs control number, order number, buyer material number, vender material number, quantity/price, gross weight/net weight, tax regulation/tax rate and tax-return document number, or, as an example shown in FIG. 3C, be a data form of the user inquiry record 102 comprising the fields of user name, inquiry method and inquired times. Similarly, through the establishment of the associative database described above, when the user enters any one of the above-mentioned data, the real-time inquiry system for importing commodities may rapidly find the corresponding data. However, it is noted that all the data forms and the data fields thereof are relevant to this particular embodiment, the discussion of all the other data fields of the data forms irrelevant to this particular embodiment is thus neglected. On the other hand, since there are a variety of system structures for the associative database, the establishment of which is a well-know technology, the discussion of which is thus neglected.

Based on the identification code entered via a network terminal device, the user identification module 30 finds the corresponding access limit of the identification code. A signal is then sent to the network terminal device in accordance with the resultant access limit and a corresponding inquiry web page is generated by the network terminal device for user inquiry. In this particular embodiment, the identification code includes at least the account number and the password corresponding to the user name, the user identification module 30 may find the access limit of the user according to the user name, account number and password entered via the network terminal device. The online real-time information inquiry system for importing commodities 1 thus determines whether the operation of the system should be continued or be terminated.

The data-searching module 40 receives the signal of access rights from the user identification module 30. According to the access rights of the user and the inquiry conditions entered via the network terminal device, the data-searching module 40 finds the Customs data of importing commodities from the database that corresponds to the inquiry conditions and matches the access rights. The Customs data of importing commodities may thus be displayed on the browser of the network terminal device through the network communication system. It is noted that, in this particular embodiment, the inquiry for Customs data of importing commodities may be performed in the manner of a full-text search. It may also be performed by predetermine one or more inquiry elements. Furthermore, the data fields in the detailed data form of the Customs data of importing commodities 101, for example, the importer company, the Customs service company, bill of lading master waybill number and order number, may be created as optional fields and provide the user to further enter more specific inquiry conditions after the optional fields.

The inquiry learning module 50 stores the records of user inquiry performed through the online real-time information inquiry system for importing commodities 1 into the database 20. The records may be used by the data-searching module 40 when the user performs the inquiry of Customs data of importing commodities again through the online real-time information inquiry system for importing commodities 1 to actively refine the inquiry criteria based on the inquiry inertia of the user and the data frequently hit by an inquiry and to enhance the inquiry efficiencies.

The steps for implementing the online real-time information inquiry method for importing commodities through the online real-time information inquiry system for importing commodities are described in the following.

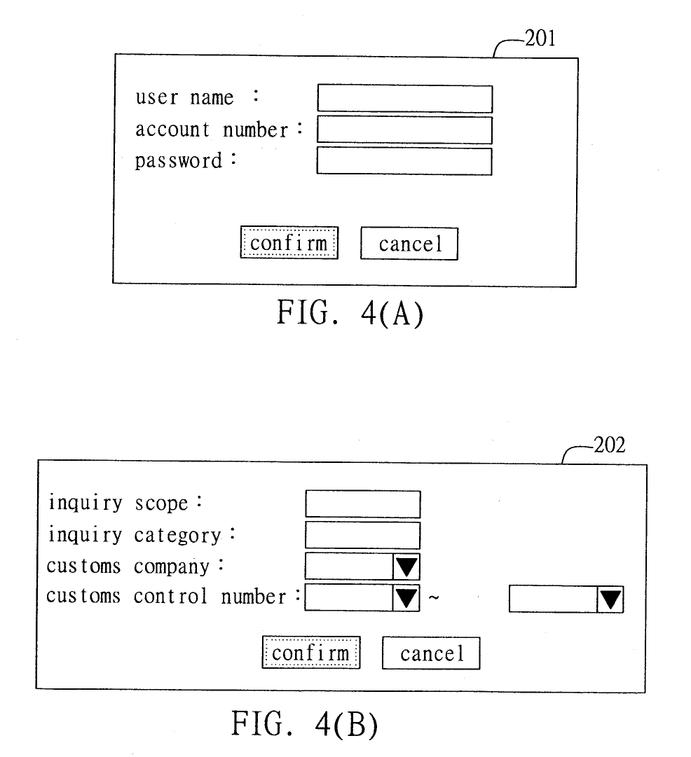

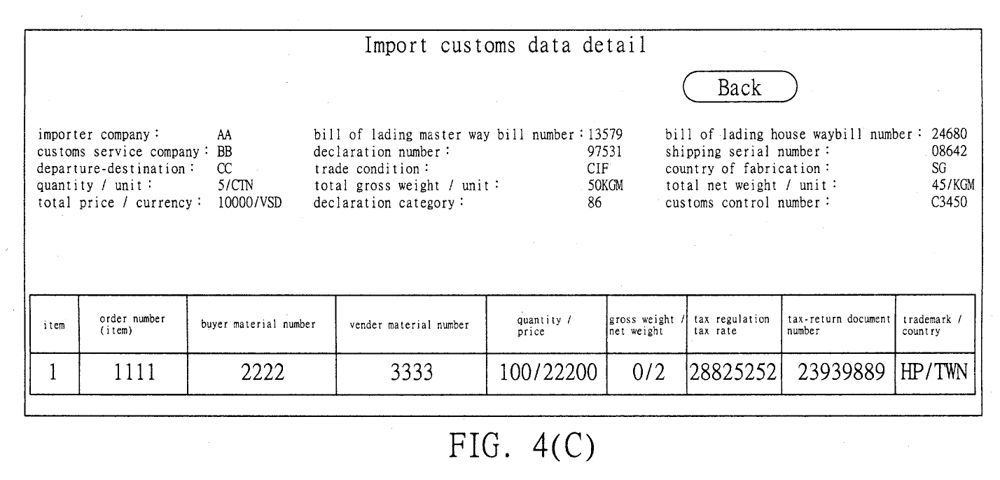

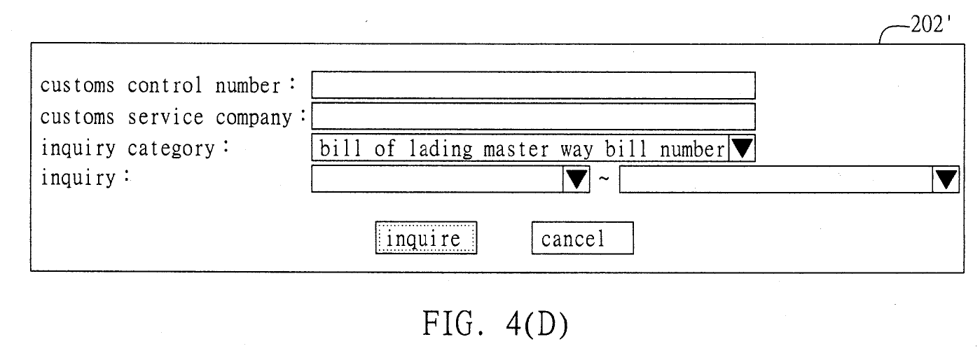

First, a user enters an identification code on a network terminal device. The network terminal device may be the network terminal device of a Customs service company 3 or the network terminal device of an importer company 4. In FIG. 4A, when the network terminal device 3 or 4 is connected with the online real-time information inquiry system for importing commodities via a browser through the network communication system 2, the online real-time information inquiry system for importing commodities 1 will display a web page on the browser of the network terminal device 3 or 4 so that the user may enter the identification code such as the user name, the account number and the password. After the identification code is entered and confirmed, the network terminal device will send it to the user identification module 30 so that the user identification module 30 may search the database 20 to see if there is any corresponding access rights of the user name, the account number and the password. If there is, the user identification module 30 then send a signal to the network terminal device 3 or 4 and the data-searching module 40, respectively, based on the access rights. After the network terminal device 3 or 4 received the signal, then display a page so that the user may enter inquiry conditions. On the contrary, if the corresponding access rights may not be found, the user identification module 30 will recognize the user as having no access rights, the online real-time information inquiry system for importing commodities is then terminated thus the operation of which may not be continued. In this particular embodiment, the user name is “H”, the account number is “heart” and the password is “2002”, which corresponds to the access limit as “S”.

Then, after the inquiry conditions are entered via the network terminal device 3 or 4, the network terminal device 3 or 4 send the inquiry conditions to the data-searching module 40. Based on the inquiry conditions entered by the user and the access rights found in the user identification module 30, the data-searching module 40 finds from the database the data of importing commodities corresponding to the inquiry conditions and matching the access rights, and displays the result on the network terminal device 3 or 4. In FIG. 4B, as described above, when the user has the access rights, the online real-time information inquiry system for importing commodities 1 may display a web page 202 for entering inquiry conditions. In this particular embodiment, it is required to fill in the fields of Customs control number and Customs company. The field of inquiry category may be selected from a plurality of category options which may include each of the name of the detailed data fields from the detailed data form of Customs data of importing commodities 101, such as the bill of lading number and order number. After the inquiry category is entered, the user may also enter the category into the field of inquiry scope to refine the scope of inquiry. In FIG. 4C, based on the detailed Customs data of importing commodities found from the database 20 corresponding to the inquiry conditions, the data-searching module 40 may display the contents on the web page 203 of the browser of the network terminal device when the user confirmed the entered conditions. As shown in the drawing, the user may fill in the fields on the web page 202. As an example, when the field of control number is filled as “C3450”, the field of Customs company is filled as “BB”, the field of inquiry category is the bill of lading master waybill number and the field of inquiry scope is filled in as “13500˜13600”, the web page 203 of the Customs data of importing commodities is displayed.

Next, the inquiry learning module 50 records the inquiry inertia, preferences or the frequently inquired data into the database 20 via the data-searching module 40. As described above, in this particular embodiment, the inquiry category is based on the bill of lading master waybill number entered by the user. The inquiry learning module 50 may store the present inquiry category into the data form of the user inquiry record 102 of the database 20. That is, add one to the number of inquiry times on the same row corresponding to the inquiry field of bill of lading master waybill number. In FIG. 3C, the data form of the user inquiry record 102 shows that the user H has performed the inquiry for 12 times by using the bill of lading master waybill number as the inquiry condition. After an inquiry is performed in this particular embodiment, as shown in FIG. 3D, the number of inquiry times, performed by user H by using bill of lading master waybill number as the inquiry condition, has increased to 13 in the data form of the user inquiry record 102.

Finally, while the user performs the inquiry again, the data-searching module 40 may refine the inquiry condition or the data scope based on the content recorded in the database 20 to enhance the inquiry efficiencies. As described above, when the user enters again into the web page 202 for entering inquiry conditions, the data-searching module 40 may pre-select the field of the inquiry category option as “bill of lading master waybill number”. That is, the inquiry learning module 50 has already had a record that the “bill of lading master waybill number” is the most frequently used inquiry category item. Thus, by listing first the category item that the user prefers, it may reduce the time wasted on selecting the inquiry category item whenever the user is performing an inquiry and enhance the inquiry efficiencies.

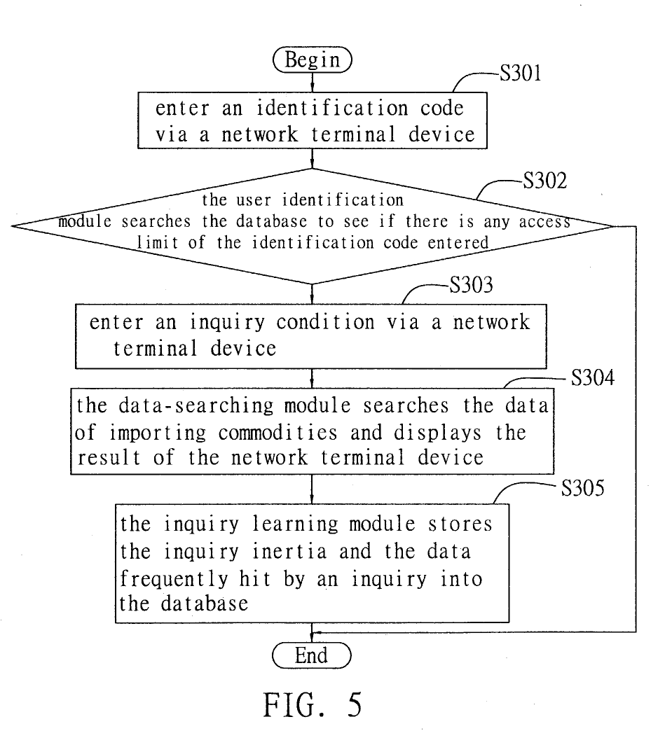

In FIG. 5 illustrating procedural steps for performing an online real-time information inquiry method for importing commodities according to the invention, the database 20 that is established on the data processing workstation 10 stores the Customs data of importing commodities, the user identification code and the corresponding data of access rights. Then proceed to step S301.

In step S301, the user may enter an identification code via a network terminal device, then proceed to step S302.

In step S302, the user identification module 30 receives the identification code from the network terminal device and finds from the database 20 whether there is the data of access rights of the identification code. Proceed to step S303 if there is, otherwise terminate the steps.

In step S303, a signal is sent to the network terminal device and the data-searching module 40 connected with the user identification module 30 so that the user may enter the inquiry condition via the network terminal device, then proceed to step S304.

In step S304, based on the user inquiry limits entered from the user identification module 30, the data-searching module 40 may find the data of importing commodities, from the database 20, corresponding to the inquiry conditions and matching the inquiry limits, and display the result on the network terminal device, then proceed to step S305.

In step S305, the inquiry learning module 50 records the data of inquiry inertia that the user performs the inquiry through the data-searching module 40 and the data frequently hit by an inquiry into the database 20. Based on the records established in the database 20 by the inquiry learning module 50, the inquiry condition may be refined and the inquiry efficiencies may be enhanced when the user performs the inquiry again through the data-searching module 40.

The online real-time information inquiry method and system according to the invention may provide a user to inquire the information of Customs data of importing commodities, online and in real-time, via a network terminal device through a network communication system. Moreover, it may also refine the inquiry condition or data scope based on the inquiry inertia and preferences or the data frequently hit by an inquiry so that the efficiency for performing the inquiry of the data of importing commodities may be enhanced.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. An online real-time information inquiry method for importing commodities, for allowing users to inquire Customs data of importing commodities via a network terminal device and a network communication system, the Customs data being stored in a database that also stores identification codes and corresponding access rights of the users, the method comprising the steps of:
entering via a user an identification code through the network terminal device;
upon receiving the entered identification code from the network terminal device, searching via a user identification module the database if there is an access right corresponding to the user identification module; if no, terminating the search; if yes, sending a signal to the network terminal device and a data-searching module connected with the user identification module, so as to allow the user to enter inquiry conditions via the network terminal device;
having the data-searching module search data of importing commodities from the database according to the access rights of the users from the user identification module and consistent with the entered inquiry conditions and display the searched data on the network terminal device; and
having an inquiry learning module record data frequently inquired by the user via the data-searching module and store the recorded data in the database, so as to allow the data-searching module to perform another data inquiry from the user based on refined inquiry conditions or data scope according to the records established in the database by the inquiry learning module, to thereby enhance efficiency of the data inquiry.

2. The method of claim 1, wherein the network terminal device is a computer.

3. The method of claim 1, wherein the network communication system is Internet, Intranet, Extranet, or a wireless communication system.

4. The method of claim 1, wherein the network communication system is a cable or wireless communication system.

5. The method of claim 1, wherein the database is an associative database.

6. The method of claim 1, wherein the identification code includes a user account and a corresponding password.

7. An online real-time information inquiry system for importing commodities, for allowing users to inquire Customs data of importing commodities via a network terminal device and a network communication system, the online real-time information inquiry system comprising:
a data processing workstation for performing data input to and output from the online real-time information inquiry system;
a database for storing the Customs data of importing commodities entered from the data processing workstation, identification codes and corresponding access rights of the users, and data frequently inquired by the users;
a user identification module for searching access rights from the database corresponding to identification codes entered from the network terminal device, and for generating corresponding inquiry web pages to which the users input inquiry conditions via the network terminal device;
a data-searching module for searching Customs data of importing commodities from the database according to the access rights of the users and consistent with the inquiry conditions input from the network terminal device, and for displaying the searched Customs data on the network terminal device via the network communication system; and
an inquiry learning module for recording and storing data frequently inquired by the users through the use of the online real-time information inquiry system, so as to allow the data-searching module to perform other data inquiries from the users based on refined inquiry conditions or data scope according to the records established in the database by the inquiry learning module, to thereby enhance efficiency of the data inquiry.

8. The system of claim 7, wherein the network terminal device is a computer.

9. The system of claim 7, wherein the network communication system is Internet, Intranet, Extranet, or a wireless communication system.

10. The system of claim 7, wherein the network communication system is a cable or wireless communication system.

11. The system of claim 7, wherein the database is an associative database.

12. The system of claim 7, wherein the identification code includes a user account and a corresponding password.
